(19) United States
(12) Patent Application Publication
(10) Pub. No.: US 2025/0087185 A1
(43) Pub. Date: Mar. 13, 2025

(54) Polymer Covered Instrument String

(71) Applicant: D’Addario & Company, Inc., Farmingdale, NY (US)

(72) Inventors: James D'Addario, Old Westbury, NY (US); Arsalan Delfanazari, Seaford, NY (US); Kim Auyeung, Brooklyn, NY (US)

(21) Appl. No.: 18/827,083

(22) Filed: Sep. 6, 2024

Related U.S. Application Data
(60) Provisional application No. 63/581,296, filed on Sep. 8, 2023.
(60) Provisional application No. 63/613,217, filed on Dec. 21, 2023.

(51) Int. Cl. G10D 3/22; D07B 1/16; G10D 3/10

(52) U.S. Cl. CPC G10D 3/22; D07B 1/162; G10D 3/10; D07B 2201/2092; D07B 2801/22

(57) ABSTRACT

A wire with a protective covering made from a non-fluorinated polymer fused to the outer surface. The wire may be part of a musical instrument string, and the covering may include a secondary polymer that is non-fluorinated. The wire exhibits high durability and shows improved strength compared to a comparable wire with fluorinated polymer covering, and the musical instrument string exhibits bright tone with low damping.

### CROSS-REFERENCE TO RELATED APPLICATION

This application claims priority to U.S. Provisional Application No. 63/581,296, filed Sep. 8, 2023, for Polymer Covered Instrument String, and U.S. Provisional Application No. 63/613,217, filed Dec. 21, 2023, for Polymer Covered Instrument String, the entire contents of which are incorporated herein by reference.

### BACKGROUND

The disclosed embodiments relate to strings for musical instruments, and, in particular, to strings that include a protective covering.

In the musical arts, strings in guitar and bass guitar string sets include wound and unwound strings. Unwound strings are typically formed from a straight steel wire or cylindrical polymer. Wound strings traditionally comprise a central core wire, multifilament wire core (twisted or straight), monofilament polymer fiber core or multifilament polymer fiber core (twisted or straight), around which a winding wire or layers of winding wires are tightly helically wrapped. Wound instrument strings have been known and in use for decades.

It is widely accepted by musicians and others in the musical instrument industry that new strings have the most preferred tone—full and with minimal damping of the natural overtones created when the string is plucked. However, when the strings are played for a matter of hours, they become contaminated with skin particles and perspiration from the musician's hands, which infiltrate the windings in wound strings. Depending upon atmospheric conditions and the musician's body chemistry, the metal wires in wound and unwound strings can also begin to corrode or oxidize, which also leads to degradation of the new string tone. This contamination and chemical degradation causes acoustical damping of various overtones and causes the string to lose its initial bright “new string” tone.

In recent years, technology has been developed that allows covering strings by wrapping a thin film polymer over the outside layer of the winding wire of wound strings. The film acts to prevent contaminants from initiating corrosion and/or getting between the windings in wound strings, and thereby dampening the tone. At present, the known processes for manufacturing such covered steel core strings require wrapping the metal strings with a fluorinated polymer film (PTFE, for example), usually followed by a curing step at elevated temperature to seal the edges of the wrapped polymer film and fuse it to the top/outer surface of the string. The existing techniques are not necessarily optimal. First, the high temperature curing process (often 350° C. or above) has been shown to weaken the high-carbon steel core wire, causing the strings to prematurely break. The early break phenomenon described herein is exacerbated in the smaller gauge strings, such as, for example, 0.022-0.039 inch diameter strings.

The temperature required to cure fluorinated polymers is so high that a multifilament polymer core melts, rendering the technique unusable with these types of strings, which make up the category of synthetic core strings most commonly used on classical guitar. Further, some fluorinated polymer coverings impart an acoustic damping on the string compared to uncovered new strings, although this damping is often viewed as an acceptable tradeoff for the protective properties of the covering. In response to alleged environmental concerns with halogenated materials, some governmental bodies have implemented, or are considering implementing, regulations restricting uses or imparting other requirements on the use of halogenated materials. These regulations may even impact uses of thin film PTFE and/or other halogenated films.

PTFE is similarly in use as a protective coating in other industries as well. For example, it is used within the medical field for film-coating items like catheters, cables, wires, tubes and implants that come into contact with bodily fluids for protection against contamination and degradation of the core materials of the respective product.

It would thus be useful to provide a non-fluorinated coating that is effective at protecting product materials from contamination caused by a use environment and/or moisture. For example, it would be useful to provide an instrument string that includes a protective film cover on the outside layer that is non-fluorinated and preferably can be cured at lower temperatures and/or for a shorter duration of time. Ultimately, it would be useful to provide a non-fluorinated covered string that avoids the reported premature breaking of the steel core wire of known covered strings, as well as a method of making such a string. Such strings can be made by using alternative polymers with lower melting points (Tₘ) than fluorinated polymers as film covering, either alone or in combination with another intermediate polymer.

It would additionally be useful to provide other products, such as catheters, cables, wires, tubes and implants that include a non-fluorinated protective film cover.

### BRIEF DESCRIPTION OF THE DRAWINGS

The inventive embodiments will be described in detail with reference to the drawings wherein like numerals represent like elements throughout:

FIG. 1 shows a representative wound instrument string in accordance with the disclosure;

FIG. 2 is another representative view of the disclosed instrument string during the manufacturing process, prior to curing of the film wrapping;

FIG. 3 is a cross-sectional view of the string of FIG. 1;

FIG. 4 shows an exemplary acoustic guitar with which the disclosed string is configured for use;

FIG. 5 is a representation of a polymer covered unwound string in accordance with the disclosure; and

FIGS. 6A and 6B collectively include a table providing data of illustrative examples of the disclosed embodiments.

### DETAILED DESCRIPTION

Among the benefits and improvements disclosed herein, other objects and advantages of the disclosed embodiments will become apparent from the following wherein like numerals represent like parts throughout the figures. Detailed embodiments of products covered by a non-fluorinated film, including covered musical instrument strings (wound and unwound), are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

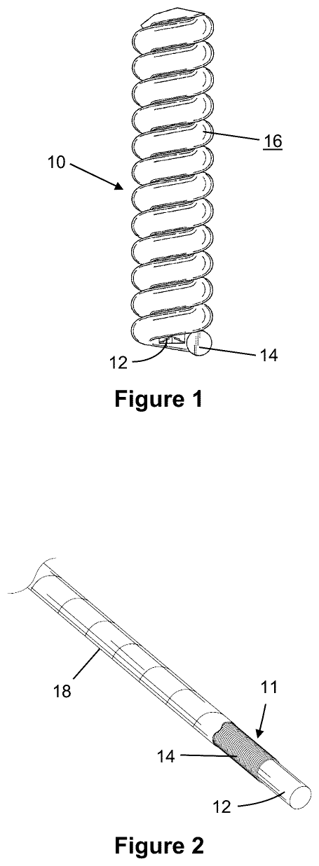

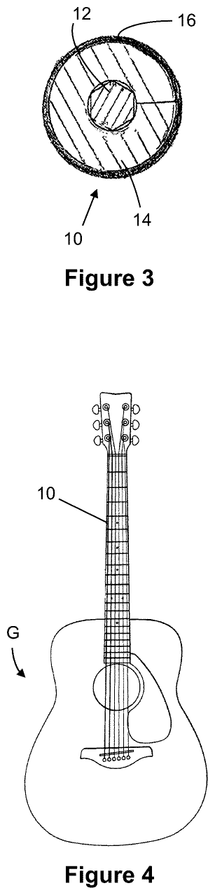

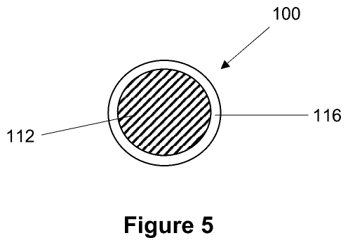

FIGS. 1 and 3 show a general representation of an embodiment of an inventive covered wound string 10, and FIG. 5 shows an embodiment of a covered unwound string 100. FIG. 4 shows a guitar G fit with at least one wound string 10 or 100.

The exemplary wound string 10 includes a central core wire 12 and at least one winding wire 14 wrapped tightly around the core wire, which in and of itself is widely known in the art. The covering layer is depicted generally as reference numeral 16. FIG. 2 shows a string precursor 11 with winding wire 14 around the core 12 and a non-fluorinated film wrapping 18 around the outer surface defined by the winding wire 14 prior to being heated to form a string 10 with a fused covering 16.

In the unwound string 100 of FIG. 5, the film covering 116 is fused around the outer surface of the wire 112, rather than that of the winding wire as in the string of FIGS. 1 and 3. Herein, the inventive strings are described in detail primarily within the context of a non-fluorinated polymer covered wound string. However, it is to be understood that non-fluorinated covered unwound strings have been made and are included within the scope of the invention.

In all of the disclosed embodiments, 10/100, the covering 16/116 is formed from a non-fluorinated polymer film 18, which may be double wrapped (or more) in some cases, depending on the thickness of the initial film. For example, strings have been prepared using a film with thickness of approximately 0.06 mil, which is double wrapped. In other embodiments, a film with thickness of 0.10 mil-0.30 mil (for example 0.10, 0.12, 0.14 and 0.16 mil thickness) was used and only single wrapped. Whether single or double wrapped, the wrapping is typically overlapped along adjacent wrap edges to ensure a fully sealed casing around the winding wire 14 without inadvertent gaps.

Strings 10 have been made using non-fluorinated polymer coverings, usually thermoplastic materials, including:
Nylons (i.e., nylon 66, nylon 6, nylon 11, nylon 12, nylon 612, copolymer nylons).
Polyesters (i.e., polyester, polyethylene terephthalate (PET), polybutylene terephthalate (PBT), polybutylene naphthalate (PBN), polyethylene terephthalate glycol (PETG)).
Polyether ether ketone (PEEK).
Polyphenylene sulfide (PPS).
Polypropylene (PP).
Polyimides (PI).

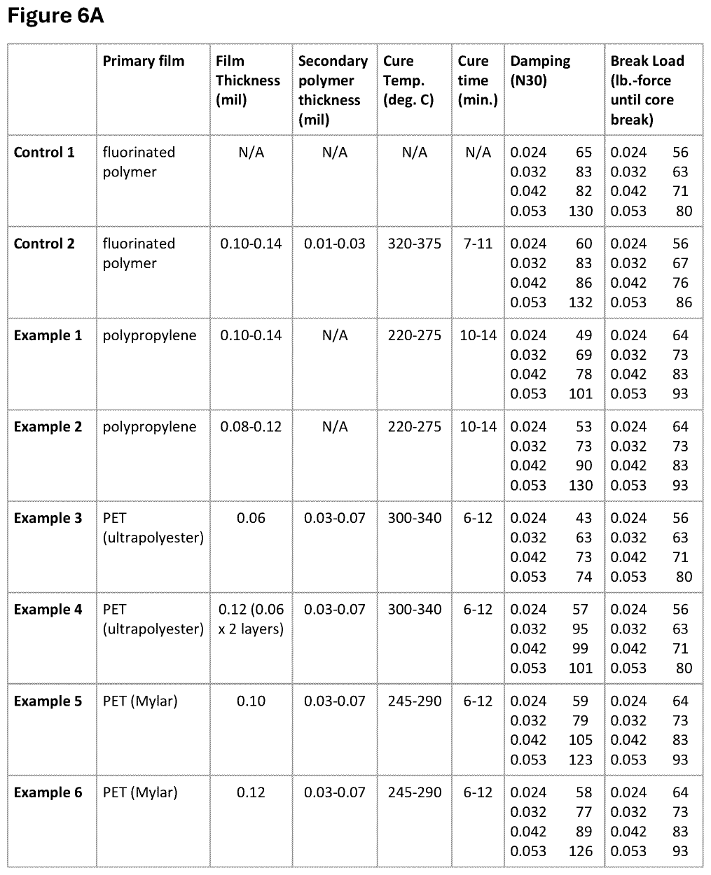

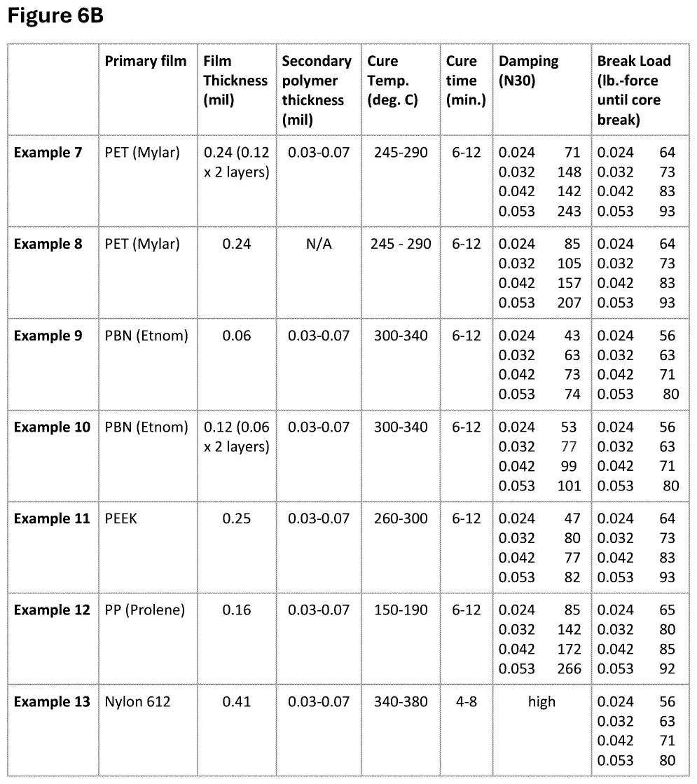

A particularly preferred embodiment includes a non-fluorinated polymer wrapping 16 formed from a polyethylene terephthalate (PET) film. Alternate preferred embodiments have a non-fluorinated polymer wrapping formed from a polyester film, such as PEEK, or a polypropylene film. Embodiments of the string 10 have been made by wrapping a non-fluorinated polymer film directly around the winding wire 14, in some cases even without including a separate intermediate polymer or adhesive to aid adhesion (see FIG. 6A, Examples 1 and 2). In these embodiments, the wrapping was cured at temperatures near the melt point of the film material within an approximate range of 200-300° C. As shown in FIGS. 6A-6B, certain preferred embodiments have been cured at temperatures of around 150-190° C., 220-275° C. or 245-290° C. to form the covered string 10. Taken cumulatively, the Examples of non-fluorinated polymer covered strings, with or without a secondary polymer, require a significantly lower curing temperature than required for making known strings with fluorinated polymer film covering with the aid of a separate adhesive component (usually temperatures of 320-450° C.). The lower curing temperature has shown to yield a string 10 with a core 12 that is significantly stronger than the core of known covered strings and comparable to traditional uncovered strings of the same specification. The lower curing temperature also helps yield a covered unwound string without significantly negatively impacting its strength, similar to the core in a wound string.

The technology disclosed and claimed herein has also found applicability for providing a protective coating on the outer surface of products aside from musical instrument strings. For example, the exemplary non-fluorinated polymer films and techniques disclosed herein can be used for film-coating products such as catheters, cables (optical or electrical, for example), wires (electrical, structural or mechanical, for example), tubes and implants. Similar to the inventive musical instrument strings, the non-fluorinated polymer film covering acts as a protective barrier to the outer surfaces of the respective product for protecting against contamination or degradation caused by environmental factors, such as bodily fluids, other moisture and/or oxidation, for example.

Examples of covered musical instrument strings with associated data are shown in FIGS. 6A-6B, wherein Examples 1-13 are wound strings with a non-fluorinated polymer covering, and the Control strings are commercially available covered strings wherein the covering is a fluorinated polymer film. The film wrapping used in each Example was prepared through known techniques of slitting a larger sheet of film into predetermined preferred widths.

As shown, Example 1 and Example 2 are similar with exception to the initial thickness of the film wrapping and minor preparation parameters. Notably, 0.024″ gauge, 0.032″ gauge, 0.042″ gauge and 0.053″ gauge strings were prepared within each of Examples 1 and 2 to test efficacy of the inventive process with a variety of string gauges. The Example 1 strings were prepared using an initial polypropylene film approximately 0.10-0.14 mil thick and cured at temperatures near the melt point of the film material (within an approximate range 220-275° C.) until the film fused to the winding wire surface and itself due to the overlapped wrapping technique. The Example 2 strings were prepared using an initial polypropylene film approximately 0.08-0.12 mil thick and cured at temperatures within an approximate range of 220-275° C. until the film fused to the winding wire surface and itself. Examples 1 and 2 were each single wrapped with overlap between successive turns of the helical film 18 and without a secondary polymer. The remaining Examples 3-13 utilize a variety of non-fluorinated polymer films, some alone and some with a secondary polymer.

As also shown in FIGS. 6A-6B, the strings of many of the Examples exhibited relatively low acoustic damping that is within an acceptable range (as tested in a laboratory setting) and even lower than that of comparable Control strings for some gauges.

Further, each of the Example strings exhibited a core strength at least as strong, and most noticeably stronger than, that of the comparable Control strings, as indicated in the break load test.

Each of the strings of Examples 1-13 also underwent durability testing wherein professional musicians played the strings continuously in a live setting. The test musicians reported the duration of playing time (number of hours) until noticing a degradation in tone, feel, or appearance of the strings. While test conditions necessarily vary somewhat due to individual playing technique and intensity, the musicians generally reported a prolonged retention of tone, smoothness, and aesthetic appearance of the strings compared to uncoated strings.

The strings of Examples 1-13 were also tested in a laboratory to assess the quality of the polymer film covering and its expected durability. The laboratory testing methods included inspection of the seams under a microscope, scraping the film covering to assess the adhesion of the film to the outer surface of the string, and testing the resistance of the covered strings to corrosive agents such as salt spray and sulfur dioxide. Each of the Examples 1-13 strings were compared to the Control strings with fluorinated polymer film covering. All Examples performed well enough to be considered commercially viable.

While Examples 1 and 2 included a polypropylene film wrapping without secondary polymer, Examples 3-13 show that a secondary polymer may be used to aid adhesion of the non-fluorinated primary polymer film wrapping. Preferably, if present, a secondary polymer has a lower melting point than the primary polymer wrapping so that the secondary polymer softens and/or melts prior to the primary polymer. Non-limiting examples of secondary polymers used in some of the Examples and which are particularly useful in combination with the primary polymers disclosed herein include one or more polyolefins, such as polypropylene (PP) and polyethylene (PE), due to their relatively low melting points. In all embodiments, the secondary polymer may be applied to a primary polymer film substrate as a coating or laminate, for example, to create a primary/secondary polymer composite film which is thereafter wrapped around the winding 14 to form the string precursor 11. In addition to PP and PE, one or more materials selected from hot melt (wax), polyethylenes, polyurethanes, nylons, acrylics, and acrylic copolymers are believed to be useful for aiding adhesion of a primary polymer covering. Notably, the secondary polymer, if present, is also non-fluorinated.

As shown in FIGS. 6A-6B, numerous exemplary strings 10 with non-fluorinated polymer covers have been manufactured with a variety of primary polymers, including polypropylene (Examples 1-2, 12), PET (Examples 3-8), PBN (Examples 9-10), PEEK (Example 11), nylon (Example 13), and PPS (data not included in FIG. 5), all showing promising results with relatively low damping and high core strength.

The various Examples exhibit different damping characteristics, and break loads as measured in a laboratory setting. Additionally, each of the Examples 1-13 strings were tested in a live playing setting for a minimum of two hours without exhibiting unacceptable degradation. Taken cumulatively, the Examples of FIGS. 6A-6B show that various different non-fluorinated polymer films can be used to form high quality music strings that exhibit low damping, high strength and corrosion resistance relative to uncovered strings of the same material and gauge.

In all Examples shown in FIGS. 6A-6B, 0.053, 0.042, 0.032 and 0.024 gauge strings were prepared in order to confirm wide applicability of the respective polymer covering. The width of the film wrap in each was within a range of 0.10-0.15 inches for 0.053 and 0.042 gauge, and 0.06-0.10 inches for 0.032 and 0.024 gauge.

Additional polymers that are suitable for use as a covering on the inventive strings include: nylon 6, nylon 66, nylon 46, nylon 612, nylon 11, nylon 12, copolymer nylons and blends of these nylon materials, polyethylene terephthalate (PET), polybutylene terephthalate (PBT), polyethylene naphthalate (PEN), polyethylene terephthalate glycol (PETG) and polystyrene (PS), polyethylene (PE), low density polyethylene (LDPE), high density polyethylene (HDPE), linear low-density polyethylene (LLDPE), modified polyethylene (mPE), polypropylene (PP), ethylene vinyl acetate (EVA), polyphenylene sulfide (PPS), polyethersulfone (PES), polyamide imide (PAI), polyether ether ketone (PEEK), polyamide (PA), polyimide (PI), Ultra High Molecular Weight Polyethylene (UHMWPE), polyhydroxyalkanoate polyester (PHA), liquid crystal polymer (LCP), and polyoxymethylene (POM). It is believed that other non-fluorinated polymers, including those specifically identified above, are usable within the scope of the disclosed invention.

Typically, the covered strings are prepared using a greater degree of overlap of the film wrapping for thinner strings and less overlap for thicker strings. For example, in some embodiments, a polymer film was single wrapped with approximately 20-60% overlap, with generally greater overlap for smaller diameter strings, such as 0.024″ and 0.032″ gauge (30-60%), and less overlap for larger diameter such as 0.042″ and 0.053″ gauge (20-50%).

It is believed that a non-fluorinated polymer film having a thickness within an approximate general range of 0.06 mil-0.30 mil, with a wrapping overlap of 10-80% yields strings having the optimal combination of durability and low damping, however, it is possible that other thicknesses are adequate for certain polymers or combinations thereof.

More preferably, the non-fluorinated polymer film has a thickness within an approximate range of 0.07 mil-0.26 mil, and more preferably within an approximate range of 0.08 mil-0.24 mil, and more preferably within an approximate range of 0.08 mil-0.20 mil, and more preferably within an approximate range of 0.08 mil-0.18 mil, and more preferably within an approximate range of 0.08 mil-0.16 mil. In some preferred embodiments, the non-fluorinated polymer film has a thickness within an approximate range of 0.08 mil-0.12 mil or within an approximate range of 0.10 mil-0.14 mil.

Strings of various gauges have been made using non-fluorinated polymer films having a thickness of 0.06 mil-0.30 mil, for example 0.08 mil-0.16 mil, with wrapping overlap of 10-80%, including 0.053″, 0.042″, 0.032″ and 0.024″ diameter acoustic guitar strings.

As noted, embodiments of the string 10 with non-fluorinated polymer cover were prepared by curing at temperatures that are generally lower than temperatures required to cure fluorinated film covers as known in the art. For example, most strings with non-fluorinated covers were prepared by curing at temperatures near the melt point of the film cover material ranging from 150-300° C. (i.e., 150, 165, 180, 200, 220, 245, 250, and 260, 280 and 300° C.). Curing duration ranged from 4-12 minutes, typically with a longer curing duration for a lower temperature, and vice versa.

The embodiments of the covered string include but are not limited to, brass and bronze alloys, silver plated copper, nickel plated steel, stainless steel, pure nickel, bare copper, tungsten, titanium, aluminum, sterling silver and any other alloy that is usable as a winding for a wound music string or a wire for an unwound string.

As disclosed herein, non-fluorinated film covered strings have been prepared that provide suitable protection and long life. The film-covered string 10 can greatly extend the tonal life of the string as compared to an uncovered string of same variety and avoids alleged environmental drawbacks of a fluorinated polymer. Players have reported a noticeable improvement in string life compared to an otherwise identical uncovered string, and embodiments of the disclosed strings have exhibited durability comparable to commercially available strings with fluorinated polymer cover.

Embodiments have been prepared that do not require a secondary polymer acting as a separate adhesive. However, some embodiments of the non-fluorinated film covered string do utilize such a secondary polymer (also non-fluorinated).

The disclosed strings 10 with steel core wires that are prepared in the manner described herein have stronger core wires than known covered strings. Due to the lower temperatures required to cure the non-fluorinated films, the core wires in the inventive strings are not significantly weakened by exposure to excessive heat during the curing process, which is known to result in premature breakage. Covered unwound strings 100 and covered wound strings 10 with a multifilament polymer core can be prepared via the disclosed technique without damaging the string or melting or damaging the more sensitive polymer core.

A film sheet is slit to narrower widths prior to wrapping around the winding of the string precursor. The slit wrapping is typically within an approximate range of 0.03-0.5 inches, more preferably within an approximate range of 0.05-0.25 inches, and even more preferably within an approximate range of 0.065-0.15 inches, and even more preferably within an approximate range of 0.073-0.125 inches. The exact preferred width of film can vary depending on the diameter of the wound string being covered. For example, wound strings for use with bass guitars that utilize relatively larger diameter wound strings can be wrapped with wider strips of film 14, while wound guitar strings are typically wrapped with relatively thinner strips of film 14.

It is generally understood that the average thickness of the film can be within an approximate range of 0.06 mil to 0.30 mil, such as for example, 0.08 mil to 0.14 mil or 0.010 mil to 0.014 mil, and achieve the improved durability described herein with acceptable acoustic properties.

Altogether, the inventive strings exhibited acceptable tone and natural feel, more comparable to an uncovered string. Examples of non-fluorinated polymer covered strings 10 achieved comparable durability to commercially available fluorinated polymer covered strings, while enhancing the core break strength. Strings 10 with multifilament polymer cores can be effectively covered with non-fluorinated polymer film without melting the cores, thus making it possible to achieve a more durable string than commercially available multifilament polymer core products. Importantly, the improved core strength and reduced risk of premature breakage is achieved without adversely impacting other critical properties of the strings, such as tone and feel.

While preferred embodiments have been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A covered musical instrument string, comprising:
a central core wire, multifilament wire core, monofilament polymer fiber core or multifilament polymer fiber core;
a winding wire wound around the central core wire, multifilament wire core, monofilament polymer fiber core or multifilament polymer fiber core, the winding wire having an outer surface; and
a cover layer fused to the outer surface of the winding wire, wherein
the cover layer is formed from a non-fluorinated polymer.

2. The musical instrument string of claim 1, wherein the cover layer comprises a secondary polymer that is non-fluorinated.

3. The musical instrument string of claim 2, wherein the secondary polymer is PP or PE.

4. The musical instrument string of claim 2, wherein the cover layer further comprises one or more surfactants.

5. The musical instrument string of claim 2, wherein the secondary polymer has a melting point (Tₘ) lower than the melting point of the non-fluorinated polymer.

6. The musical instrument string of claim 2, wherein the cover layer is formed of a non-fluorinated polymer impregnated, coated or laminated with a secondary polymer.

7. The musical instrument string of claim 2, wherein the secondary polymer is selected from the group consisting of hot melt (wax), polyurethane dispersions, nylon dispersions, acrylic emulsions, and acrylic copolymer dispersions and combinations thereof.

8. The musical instrument string of claim 1, wherein the cover layer is formed from a polymer film having an average thickness within an approximate range of 0.04-0.16×10⁻³ inches.

9. The musical instrument string of claim 8, wherein the polymer film has an average thickness within an approximate range of 0.10-0.14×10⁻³ inches.

10. The musical instrument string of claim 1, wherein the cover layer is formed from a polymer selected from the group consisting of nylon 6, nylon 66, nylon 46,nylon 612, nylon 11, nylon 12, copolymer nylons and blends of these nylon materials, polyethylene terephthalate (PET), polybutylene terephthalate (PBT), polyethylene naphthalate (PEN), polyethylene terephthalate glycol (PETG) and polystyrene (PS), polyethylene (PE), low density polyethylene (LDPE), high density polyethylene (HDPE), linear low-density polyethylene (LLDPE), modified polyethylene (mPE), polypropylene (PP), ethylene vinyl acetate (EVA), polyphenylene sulfide (PPS), polyethersulfone (PES), polyamide imide (PAI), polyether ether ketone (PEEK), polyamide (PA), polyimide (PI), Ultra High Molecular Weight Polyethylene (UHMWPE), polyhydroxyalkanoate polyester (PHA), liquid crystal polymer (LCP), and polyoxymethylene (POM).

11. The musical instrument string of claim 10, wherein the cover layer further comprises a secondary polymer that is non-fluorinated.

12. The musical instrument string of claim 1, wherein the cover layer is formed from a polymer selected from the group consisting of nylons, polyesters, PEEK, PPS and PP.

13. The musical instrument string of claim 12, wherein the polymer is selected from the group consisting of nylon 66, nylon 6, nylon 11, nylon 12, copolymer nylons, PET, PBT, PBN, PETG, PEEK, PPS and PP.

14. The musical instrument string of claim 1, wherein the core is formed from a monofilament or multifilament polymer fiber.

15. The musical instrument string of claim 1, wherein the non-fluorinated polymer is fused directly to the winding wire without a secondary adhesive.

16. A covered musical instrument string, comprising:
a musical instrument string defining a metallic outer surface; and
a cover layer fused to the outer surface, wherein
the cover layer is formed from a non-fluorinated polymer.

17. The covered musical instrument string of claim 16, wherein the musical instrument string comprises:
a central core wire, multifilament wire core, monofilament or multifilament polymer fiber core, or multifilament polymer fiber core; and
a winding wire wrapped around the central core wire, multifilament wire core, multifilament polymer fiber core or multifilament polymer fiber core, the winding wire defining the outer surface.

18. The covered musical instrument string of claim 16, wherein
the cover layer comprises a primary polymer and a secondary polymer different from the primary polymer, and
each of the primary polymer and secondary polymer is non-fluorinated.

19. A process for making a covered musical instrument string, comprising the steps of:
providing a central core wire, multifilament wire core, monofilament polymer fiber core or multifilament polymer fiber core;
winding a winding wire around the central core wire, multifilament wire core, monofilament polymer fiber core or multifilament polymer fiber core;
wrapping a film layer comprising a non-fluorinated polymer around the winding wire to form a string precursor; and
heating the string precursor at a temperature and for a duration sufficient to cure the film layer and fuse it to the winding wire, thereby forming the covered string.

20. The process of claim 19, wherein the film layer is a composite of the non-fluorinated polymer and a secondary non-fluorinated polymer.

21. The process of claim 20, wherein the composite is formed of a non-fluorinated polymer impregnated, coated or laminated with the secondary non-fluorinated polymer.

22. The process of claim 20, wherein
the non-fluorinated polymer is selected from the group consisting of nylon 6, nylon 66, nylon 46, nylon 612, nylon 11, nylon 12, copolymer nylons and blends of these nylon materials, polyethylene terephthalate (PET), polybutylene terephthalate (PBT), polyethylene naphthalate (PEN), polyethylene terephthalate glycol (PETG) and polystyrene (PS), polyethylene (PE), low density polyethylene (LDPE), high density polyethylene (HDPE), linear low-density polyethylene (LLDPE), modified polyethylene (mPE), polypropylene (PP), ethylene vinyl acetate (EVA), polyphenylene sulfide (PPS), polyethersulfone (PES), polyamide imide (PAI), polyether ether ketone (PEEK), polyamide (PA), polyimide (PI), Ultra High Molecular Weight Polyethylene (UHMWPE), polyhydroxyalkanoate polyester (PHA), liquid crystal polymer (LCP), and polyoxymethylene (POM), and
the secondary non-fluorinated polymer is selected from PP and PE.
